(19) United States
(12) Patent Application Publication
(10) Pub. No.: US 2019/0387721 A1
(43) Pub. Date: Dec. 26, 2019

(54) OPEN SEA FISH PEN

(71) Applicant: Aquaculture Evolution Inc., Riverview (CA)

(72) Inventors: Phillip Dobson, Riverview (CA); David Hoar, Riverview (CA)

(73) Assignee: Aquaculture Evolution Inc., Riverview (CA)

(21) Appl. No.: 16/207,015

(22) Filed: Nov. 30, 2018

Related U.S. Application Data
(60) Provisional application No. 62/690,272, filed on Jun. 26, 2018.

(51) Int. Cl. A01K 61/65

(52) U.S. Cl. CPC A01K 61/65

(57) ABSTRACT

An open sea fish cage includes a fish enclosure, a floatation collar, and a weight ring. The fish enclosure allows water to flow therethrough. The floatation collar engages an inboard portion of the floatation collar, and includes a plurality of floatation segments that are connected by flexible joints to adjacent floatation segments. A weight ring assembly is suspended from an outboard portion of the floatation collar with first tension members. At least most of the fish enclosure is disposed vertically between the floatation collar and the weight ring assembly.

### CROSS-REFERENCE TO RELATED APPLICATION

This application claims the benefit of U.S. Provisional Patent Application No. 62/690,272, filed Jun. 26, 2018, the disclosure of which is hereby incorporated by reference herein.

### BACKGROUND

The world supply of food has failed to grow as fast as demand, causing prices to rise faster than many people's ability to afford it. The United Nations predicts that the world's population will grow to 10 billion from the present 7 billion in the next 30 years. They also claim that presently one billion people are severely undernourished or starving. Generous countries allocate food aid in dollars, and a doubling of the price in the past 8 years has halved the food aid available in terms of actual nourishment, resulting in hundreds of thousands of deaths.

The seas have historically provided a sufficient and easily accessible supply of protein, but the increase in world population and their ability to purchase quality protein have increased demand beyond the limits of the wild fishery and agriculture's ability to satisfy it.

Land-based agriculture and land-based aquaculture require vast amounts of cleared land, water, and energy, particularly in the production of protein supply animals. It requires hundreds of gallons of water in the form of irrigation and many pounds of feed protein to create a pound of beef, pork, or chicken.

Land-based aquaculture requires massive amounts of energy, mostly to directly or indirectly supply oxygen to the fish, either through an unending river of oxygenated water, or through direct infusion from oxygen generators. Further, these facilities must recirculate water not only to get the oxygen to the fish, but also to carry away generated waste. Transport of this waste to a disposal site requires additional energy. The power requirements of a land-based aquaculture operation that would replace an average open ocean system would power a small city, and considering the growing threat of global warming its carbon footprint compared with ocean sites must eliminate it from serious aquaculture discussions.

Aquaculture conducted in the ocean displaces no water, requires very little land, has a feed efficiency many times more efficient than that of land-based agriculture operations and uses a small fraction of the energy required to raise equivalent amounts of protein in land-based aquaculture and agriculture operations.

The world needs a cheap and sustainable source of food. The restrictions of a land-based solution are irrefutable and uncompromising, leaving only the sea; and fortunately, the sea covers 71% of the globe, accounting for 96.5% of the world's water.

The first criterion of our future food supply system is that it must be economical or it will not be available to most of the world's population. The second is that it must be sustainable, or, by definition, it will become extinct.

Politically, expanding the present efficient inshore aquaculture industry is a daunting task, and politics may eventually eliminate many existing installations. This leaves only the offshore for expansion, where present inshore equipment cannot survive, or cannot efficiently operate. Many massive offshore projects and cost-prohibitive land-based alternatives have sprung out of this self-evident need, but they are so capital intensive that they ratchet up the cost of protein to an unacceptable level.

The fish pen (or fish cage) disclosed here has many advantages over elaborate prior art and therefore expensive designs, but the most important advantages are justifiable capital cost and high operating efficiency. This fish cage invention disclosed herein is simple, costing little more than the inshore cages in use now, and the same tried and proven husbandry practices are applicable.

### SUMMARY

A single containment or plural containments for fish in an aqueous environment incorporates a semi-rigid top floatation circular or other shape device that combines controllable floatation and a bottom-weighted semi-rigid circular or other shape device to maintain vertical tension on the fish containment system. The top floatation and bottom weighting system are shape-maintained by cross-linked mechanisms, or other means attached to the floatation and/or weight system. The fish enclosure is largely structurally independent of the floatation and/or weight system, being fastened with flexible connections at the bottom weight system and constructed at the top so the float sections rotate freely around an axis common to the junction between the top and side enclosures; thereby avoiding transfer of most of the structural loading from those members. The independent nature of the enclosure allows for a wide variety of enclosure systems and materials without compromising the structure.

The fish containment system is enclosed by netting or other material with sufficiently small openings to contain the marine species involved while allowing minimally restricted passage of water and oxygen; said enclosure being attached to the structure with a flexible arrangement of constraints.

The unique upper floatation system and a depth-limiting system of surface buoys connected to and acting upon the weight ring control the cage's position in the vertical column of water. Alternatively, or additionally, on some sites the vertical position can be controlled by weights suspended under the system.

The lateral position is controlled mainly by, but not limited to connections to a position-controlling device such as anchors, a single point mooring, a grid mooring system, or alternatively by a powered vessel.

Flexible and adjustable connectors interconnect the upper float system and lower weight ring systems, adaptable to a wide range of enclosure depths and enclosure tension requirements. Rigid members may or may not be added or substituted to further maintain configuration.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a plan view of a fish cage system 10 in accordance with the present disclosure illustrating an outer floatation assembly 101 formed from floatation segments that are connected using flexible joints 100, an optional top enclosure support mechanism 102, and bottom radial connectors 103.

FIG. 2A is a section view of the cage system 10 shown in FIG. 1 on the water surface illustrating the typical waterline 104 of a surfaced cage 10, outer floatation assembly 101, optional top enclosure support mechanism 102, bottom weight ring assembly 105, weight ring suspension members 106, enclosure bottom 107, enclosure side 108, enclosure top 109, bottom radial connections 103, horizontal or lateral position control connections or line assemblies 111 and 112 (indicated by arrows), and optional depth control weights 113 and 114.

FIG. 2B is a section view of the cage 10 shown in FIG. 1 illustrating an installed optional nursery or early growth containment system (nursery enclosure) 115 and positioning lines 116 for the nursery containment system 115.

FIG. 3 is a section view of a float element in one embodiment of the float assembly 101 illustrating adaptable floatation elements 118, a typical fish enclosure attachment at the railing 119, flexible connectors 120 between the weight ring assembly 105 and the fish enclosure 107, 108, 109, and weight ring assembly connections 106 to the float assembly 101.

FIG. 4 is a section view of a float section 117 of the float assembly 101 illustrating a typical buoyancy tank 118, laterally adjustable to balance the cage element as it submerges and rises to the surface.

FIG. 5 is a plan view of the cage 10 shown in FIG. 1 illustrating a fastening system 122 attached between the weight ring assembly 105 and the positioning line 123.

FIG. 6 is a section view of the cage 10 shown in FIG. 1 at the water surface 104, and submerged supported by buoys 124 through suspension member of flexible connector 125 attached to junction 127.

FIG. 7 is a section view of the cage 10 shown in FIG. 1 utilizing weights 113 suspended from the weight ring assembly 105 to limit depth in one embodiment, a single weight 114 suspended from the intersection of the bottom radial connectors 103, or from a mort trap 110 fixed to the enclosure bottom 107, to limit depth in another embodiment.

FIG. 8 illustrates two of the cages 10 shown in FIG. 1, wherein one cage 10 is raised to the water surface 104 and one cage 10 is suspended below the water's surface 104 by flexible connectors 123, 125.

### DETAILED DESCRIPTION

This invention relates to an aquaculture system, particularly designed to be useful in environments of very high energy. Due to its low capital costs and high operating efficiencies it also lends itself well to very low energy environments. The system can be routinely submerged below the ocean surface environment where algal blooms, human interference, storms and other dangers exist, and easily resurfaced using the flexible buoyancy system as requirements dictate. The system can be anchored to the sea bottom at multiple points, or allowed to swing or rotate around a single point anchoring system. The cage design enables and encourages a single or multi-cage towed configuration where a constantly changing location means no concentration of waste, and a controllable through-cage transfer of water and oxygen.

The design of the unique sub-surface connection to the weight system frees the surface floatation system to move and adapt to waves and current instead of fighting them. Together with the adjustable buoyancy of the floatation systems, almost all of the destructive and/or undesirable forces acting on the containment system are relieved while maintaining the shape and the volume of the enclosure. Additionally, the elimination of outside attachments to the cage at or near the surface allows flexibility of access and eliminates work vessel propeller entanglements. The adaptability of the floatation elements enables multiple configurations for raising and lowering the system with a minimal amount of air and allows adjustment of the balance system to the desired reserve buoyancy, fish enclosure tension and weight of the enclosure.

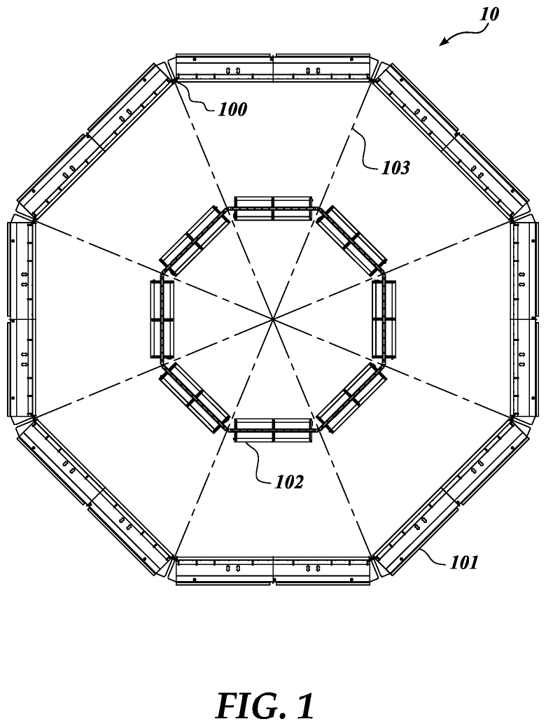

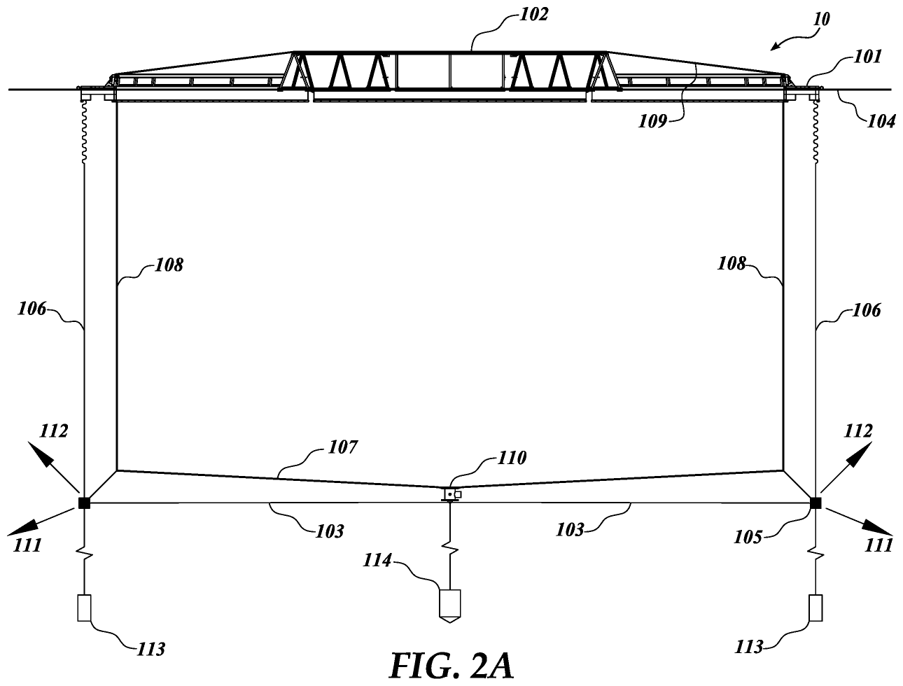

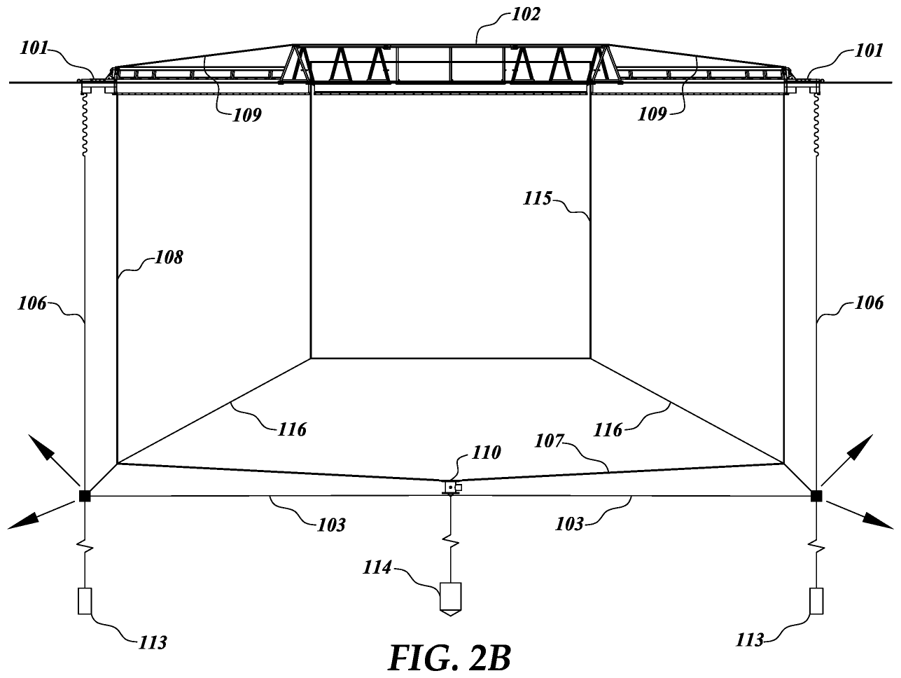

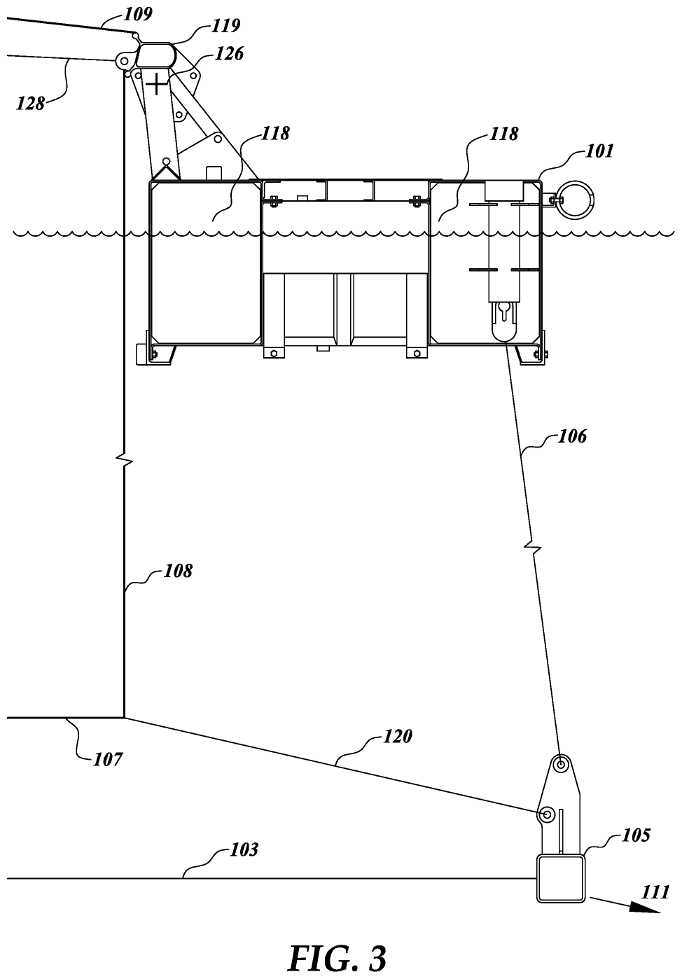

Refer to FIG. 1 which shows a plan view of the cage 10 in accordance with the present invention on the surface of a body of water. The cage 10 is designed to contain fish within an enclosure 107, 108, 109 (FIG. 2A) surrounded and supported by a floatation assembly 101, and may be of any practical size with any number of sections. The horizontal shape of the cage 10 is maintained by a system of lower radial attachment elements or connectors 103 attached to the weight ring assembly 105, and a system of upper radial attachment elements or connectors 128 (FIG. 3) attached to the floatation assembly 101. As with a bicycle wheel, the horizontal shape is ultimately maintained by tension on the radial connectors 103, 128.

A top enclosure support mechanism 102 supports the fish enclosure top 109 at the surface, and maintains the shape tension required in the enclosure top 109 when submerged. The enclosure top 109 is required to contain the fish during submersion, but may be removable for maintenance and harvesting.

Referring to FIG. 2A, the vertical enclosure side 108 is maintained in the extended position shown by the separation between the variable floatation assembly 101 and the weight ring assembly 105.

As discussed below, the depth of submersion of the cage 10 may be controlled with a system of weights suspended under the cage 10. The weight system may consist of a single weight 114 suspended at the intersection of the bottom radial connectors 103 or from a fish mort trap 110 fixed to a center portion of the enclosure bottom 107, or may comprise a plurality of weights 113 suspended below the weight ring system 105, for example, so that the distance from the weight 113, 114 to the sea bottom is equal to the desired depth of submersion below the surface 104.

Referring to FIG. 2B, a nursery enclosure 115 is designed to function as a nursery, holding small fish until they are large enough for the main enclosure comprising enclosure bottom, side, and top elements 107, 108, 109. Suspended from the top enclosure support mechanism 102, the nursery enclosure 115 is secured at the junction between the enclosure side 108 and bottom 107 using flexible positioning lines 116.

Referring to FIG. 3, the floatation segments of the floatation assembly 101 include a framework including a platform, and a plurality of floatation elements or buoyancy members 118 attached to the framework under the platform, wherein at least some of the buoyancy members are configured to be movable between an outboard position and an inboard position. The cross section of the floatation assembly 101 illustrates the junction axis where the enclosure top 109 and the enclosure side 108 join at the top railing 119 in close proximity to the horizontal axis 126 of the flexible joint 100 (FIG. 1) between float sections of the floatation assembly 101. This near-common rotational axis prevents the float sections of the floatation assembly 101 from transferring torque, tension and/or other undesirable forces to the enclosure assembly 107, 108, 109 when the floatation assembly 101 is subjected to extreme environmentally related forces. The joint 100 is constructed with enough flexibility to allow the float sections of the floatation assembly 101 to twist about the joint 100 relative to one another within the maximum anticipated range, and to be fail-safe under all anticipated conditions

Because of its high drag the enclosure 107, 108, 109 is essentially stationary in the water inside a wave and in a state of near equilibrium. The main forces acting on the enclosure are those transferred from the float sections of the floatation assembly 101. If the float sections of the floatation assembly 101 are free to twist about an axis common to the enclosure and are free to move laterally largely independent of the cage positioning system, free from lateral constraints, these forces are mitigated. This is only possible if the upper enclosure junction and the horizontal center of rotation (axis 126) of the float section at the joint 100 are in close proximity, and if the lateral positioning assembly 111 is located at the bottom of the cage 10. The bottom junction of the fish enclosure, where the enclosure bottom 107 meets the enclosure side 108 is secured using flexible connectors 120 from the bottom junction to the weight ring assembly 105 using the appropriate tension to balance the floatation assembly 101 and tighten the fish enclosure to the required specifications.

Referring again to FIG. 3, the cross section illustrates adaptable floatation elements 118 employed as fixed floatation. The number of floatation elements 118 required to supply the desired fixed buoyancy in the floatation assembly 101 can be distributed in the floatation assembly 101 as required to adjust the center of buoyancy and the total buoyancy of each section of the floatation assembly 101 relative to the weight and desired tautness of the enclosure. The weight of enclosure materials in water may vary from floating, as is the case with clean ultrahigh molecular weight polyethylene fiber, e.g. Dyneema® nets, to very heavy in the case of metallic nets or dirty nets of any material. The addition or removal of floatation elements 118 to balance the system is a routine procedure easily accomplished without special equipment.

Referring again to FIG. 3, the weight ring system 105 may be lowered or raised by lengthening or shortening the adjustable suspension members 106. The effect of this adjustment can be used to set the tautness of the enclosure, balance the floatation assembly 101, or to adapt the weight ring assembly 105 to the depth of the chosen enclosure.

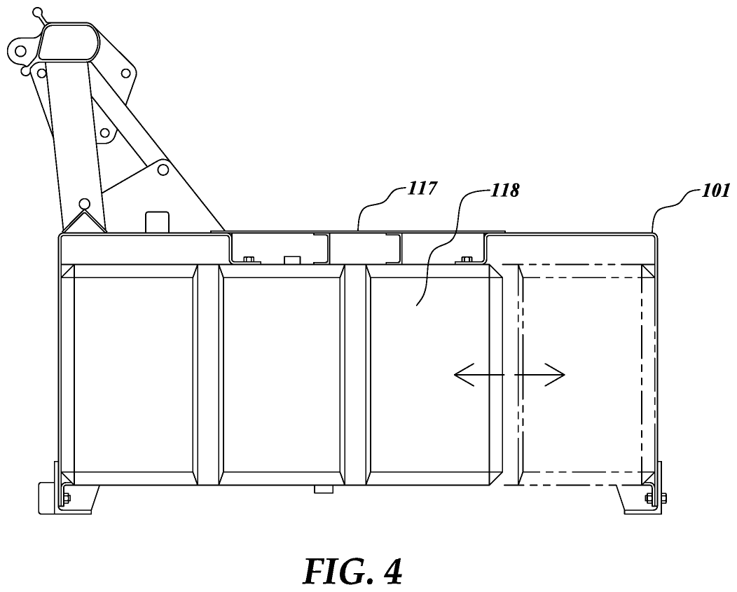

Referring to FIG. 4, the cross section drawing of the floatation assembly 101 illustrates the location and limits of adjustment of the buoyancy tanks 118. The number of buoyancy tanks 118 in each float section of the floatation assembly 101 will vary depending on the specific design. In this embodiment there are two sets of buoyancy tanks 118 in each float section, arranged so that one set of buoyancy tanks 118 are variable buoyancy tanks and control the depth and the ascent and descent rate of the cage when submerging or surfacing, while the second set of buoyancy tanks 118 controls the reserve buoyancy as required for servicing the cage 10. Some or all of the buoyancy tanks 118, may be moved laterally to facilitate alignment of its center of buoyancy with the center of buoyancy and common center of gravity of the associated float section of the floatation assembly 101, thereby maintaining the float section's balance and attitude in all vertical positions, surfaced or submerged.

A system of hoses, first valves and restrictors connected to an appropriate air supply (not shown) may be used to force air into the buoyancy tanks 118, thereby evacuating the water so that the cage will rise. The buoyancy tanks 118 may be fitted with a second set of valves, or alternatively an air diversion system (not shown) incorporated into the first valves, which allows air to exit and water to flood the buoyancy tanks 118, thereby submerging the cage 10. The air system may permit remote or manual operation. For example, the variable buoyancy tanks 118 may be configured to receive and retain water to transition the open sea fish cage to a net negative buoyancy condition, and to displace retained water with air to transition the open sea fish cage to a net positive buoyancy condition.

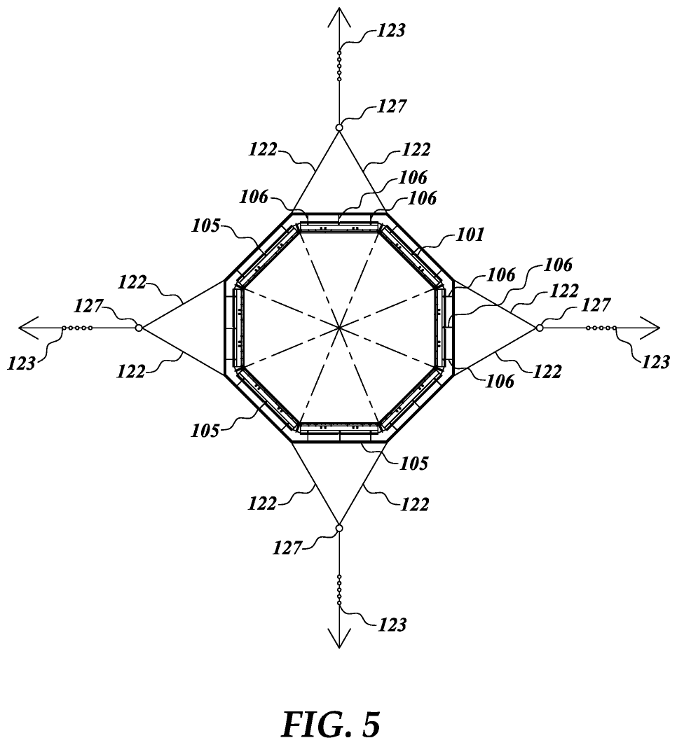

Referring to FIG. 5, a plan view of a typical anchoring or other lateral positioning lines 123 is in this case a four-sided system. In this embodiment the weight ring assembly 105 is formed from a plurality of weight ring segments connected end to end to form the weight ring assembly 105, and the weight ring assembly 105 has a larger diameter than the floatation assembly 101. In other embodiments the system could have more or fewer side connections. A single cage 10 is shown, but any number of cages may be arranged in a grid by modifying the horizontal fastening arrangement.

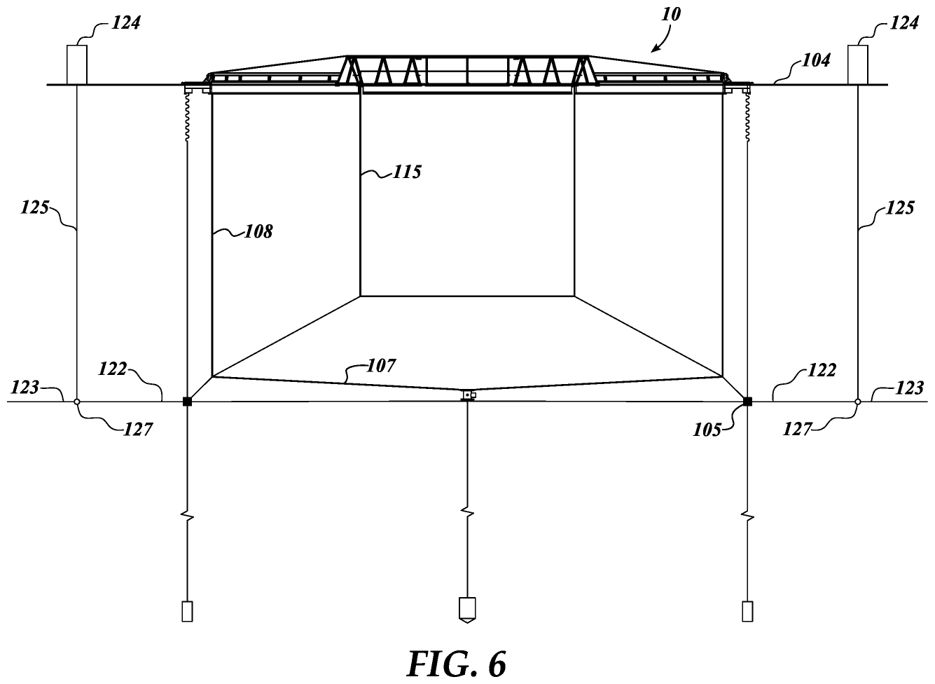

Referring to FIG. 6, the main positioning lines 123 end directly below a buoy 124, at a junction 127 with a line assembly 122 from said junction 127 to the weight ring assemble 105. The elevation of the junction 127 is near the elevation of the weight ring assembly 105 and is supported by a vertical connector 125 from the buoy 124 to the junction 127. The forked line assembly 122 includes flexible connectors between the junction 127 and the weight ring assembly 105. The depth of the junction 127 below the buoy 124 is determined by the desired depth of the system when submerged. The buoy 124 is sized to support the cage when submerged.

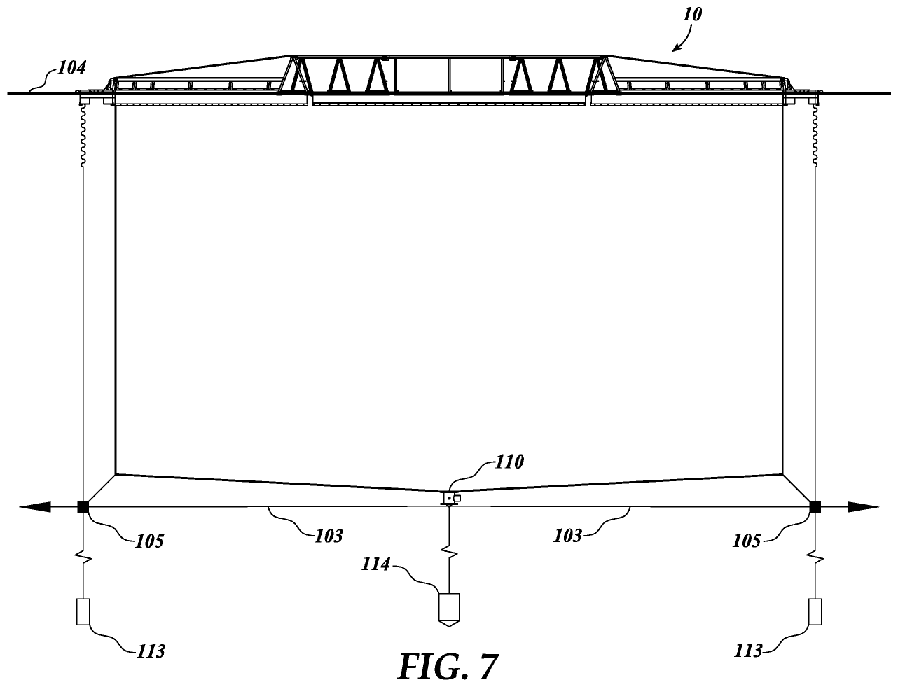

Referring to FIG. 7 illustrating two alternative means of restricting the submerged depth of the cage system 10 using weights 113, 114 suspended below the cage system such that the distance between the weight(s) 113, 114 and the sea floor (not shown) equals the desired depth of submersion. As discussed above, the systems may be a single weight 114 suspended from the junction of the radial members 103 or from a mort trap 110 fixed to the enclosure bottom 107, or multiple weights 113 suspended from the weight ring assembly 105.

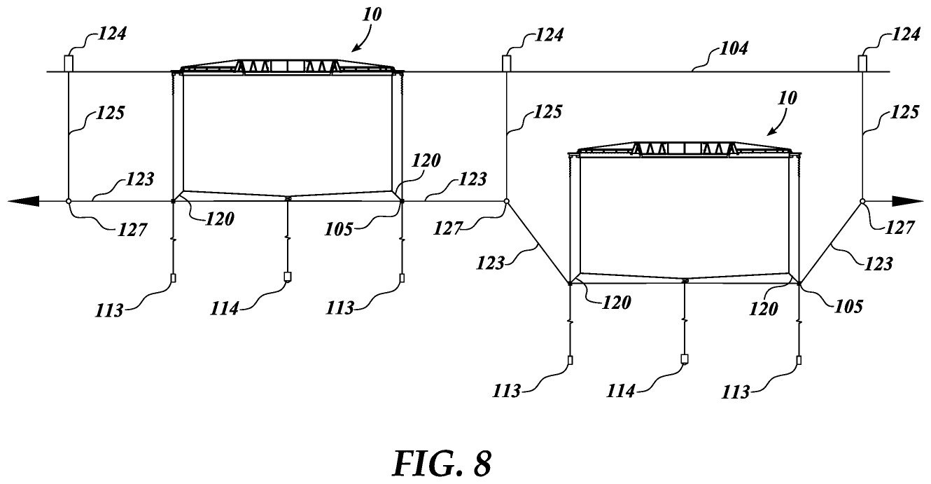

Referring to FIG. 8 illustrating, illustrating two cages 10, one cage 10 floating at the water surface 104 and one cage 10 suspended below the water's surface 104 by flexible connectors 125 from the weight ring assembly 105 to the junction 127, further connected to surface buoys 124 through flexible connectors 125. Flexible connectors 123 to the positioning system restrict the lateral movement of the junction 127.

While illustrative embodiments have been illustrated and described, it will be appreciated that various changes can be made therein without departing from the spirit and scope of the invention.

The embodiments of the invention in which an exclusive property or privilege is claimed are defined as follows:

1. An open sea fish cage comprising:
a fish enclosure configured to allow water flow therethrough;
a floatation collar attached to the fish enclosure, wherein the fish enclosure engages an inboard portion of the floatation collar and the floatation collar comprises a plurality of floatation segments that are connected by flexible joints that are located at the inboard portion of the floatation collar to adjacent floatation segments; and
a weight ring assembly suspended from an outboard portion of the floatation collar with a plurality of first tension members and wherein at least most of the fish enclosure is disposed vertically between the floatation collar and the weight ring assembly.

2. The open sea fish cage of claim 1, wherein the buoyancy of the floatation collar is adjustable, such that the fish enclosure may be selectively transitioned between a net positive buoyancy condition and a net negative buoyancy condition.

3. The open sea fish cage of claim 1, wherein the weight ring assembly comprises a plurality of ring segments.

4. The open sea fish cage of claim 1, wherein the floatation segments comprise a framework including a platform, and a plurality of buoyancy members attached to the framework under the platform, wherein at least some of the buoyancy members are configured to be movable between an outboard position and an inboard position.

5. The open sea fish cage of claim 4, wherein at least some of the buoyancy members are variable buoyancy members.

6. The open sea fish cage of claim 5, wherein the variable buoyancy members are configured to receive and retain water to transition the open sea fish cage to a net negative buoyancy condition, and to displace the retained water with air to transition the open sea fish cage to a net positive buoyancy condition.

7. The open sea fish cage of claim 1, wherein the plurality of first tension members suspending the weight ring assembly from the floatation collar comprise an adjustable length segment.

8. The open sea fish cage of claim 1, wherein the plurality of first tension members suspending the weight ring assembly from the floatation collar comprise a flexible shock absorbing segment.

9. The open sea fish cage of claim 1, wherein the fish enclosure further comprises a mort trap configured to receive fish from a lower end of the fish enclosure.

10. The open sea fish cage of claim 1, wherein each of the plurality of floatation segments is connected by a corresponding second tension member to a non-adjacent one of the other floatation segments.

11. The open sea fish cage of claim 4, wherein at least some of the plurality of buoyancy members are variable buoyancy members, and wherein the variable buoyancy members further comprise a valve system.

12. A fish cage and anchoring system comprising the open sea fish cage of claim 1, further comprising a plurality of anchor lines that connect the weight ring assembly to a corresponding plurality of spaced apart anchors, either directly or indirectly through adjacent cages in a grid system.

13. The open sea fish cage and anchoring system of claim 12, wherein the plurality of anchor lines may further comprise a plurality of underwater buoys attached at an intermediate location to a corresponding one of the plurality of anchor lines as shock mitigating and anchor line tensioning devices.

14. The open sea fish cage and anchoring system of claim 13, wherein each of the plurality of anchor lines comprises a portion having proximal ends that connect to the weight ring assembly and a distal end that is attached to an anchor line connecting junction suspended from a surface buoy.

15. The open sea fish cage and anchoring system of claim 14, wherein the plurality of anchor lines are connected directly or indirectly to the weight ring assembly at a minimum of three points.
